(19) United States
(12) Patent Application Publication
(10) Pub. No.: US 2010/0223179 A1
(43) Pub. Date: Sep. 2, 2010

(54) System and Method for Transaction Security

(76) Inventor: Peter Mergenthaler, Latana, FL (US)

Correspondence Address: CLIFFORD H. KRAFT, 320 ROBIN HILL DR., NAPERVILLE, IL, 60540, US

(21) Appl. No.: 12/552,172

(22) Filed: Sep. 1, 2009

Related U.S. Application Data
(63) Continuation of application No. 11/289,008, filed on Nov. 29, 2005, now abandoned.
Application No. 11/289,008 is a continuation-in-part of application No. 11/099,091, filed on Apr. 5, 2005, now abandoned.

(51) Int. Cl. G06Q 50/00; G06Q 10/00; G06Q 40/00; G06F 15/16

(52) U.S. Cl. 705/38; 705/316; 709/224

(57) ABSTRACT

A system and method for controlling fraud in presentations, sales and transactions using electronic devices to collect biometric data or other identification from a person seeking access to a property or wishing to participate in a transaction. The device located on real property can communicate with a remote computer that decides whether to allow or deny access. Persons seeking access can be categorized, and different access procedures can be used based on the person's category. The system can track and record all accesses, egresses, offers and counter-offers made on the property or transaction and other types of data about the history of the participants, presentation, or transaction from when it is started until it is concluded. The devise will also be portable for transactions other than real estate specific

This application is a continuation of co-pending application Ser. No. 11/289,008 filed Nov. 29, 2005 which was a continuation-in-part of application Ser. No. 11/099,091 filed May 23, 2005, now abandoned. Application Ser. Nos. 11/289,008 and 11/099,091 are hereby incorporated by reference.

### BACKGROUND

1. Field of the Invention

The present invention relates generally to the field of sales, presentations and transactions including real estate sales and more particularly to a system and method for assuring the fairness and security of a presentation, sale or transaction.

2. Description of the Prior Art

It is known in the art of real estate sales and other transactions for there to be a listing agent and various selling agents. A listing agent lists a house or piece of property for sale by signing a sales contract with the seller and probably listing the property in a multiple listing computer service. In many cases, the seller must leave the property before it is sold. In this case, it is customary to put a lock box on the front door of a house or elsewhere on a property containing a key. This key allows other sellers who wish to show the house or property to obtain access.

Lock boxes are generally accessible by a master key or by a combination known to all authorized agents in an area.

The problem with the lock box is that the seller/owner, and even the listing agent, has no knowledge of exactly who has been in the house or property, how many times it was shown, who showed it, or whether there was any type of offer made. Most real estate agents, by agreement, leave a copy of their card in the house or on the property when they bring a perspective buyer to see it. However, this is enforced only through an honor system. Listing agents have an incentive to sell properties they have listed because of the higher commission. Thus, when a perspective buyer enters a real estate broker's office, the broker would much rather sell them one of their own listings than another agent's listing. However, the perspective buyer might wish to see several houses or properties. A dishonest broker might show several properties belonging to other agent to get a feel for the buyer, and to make it look like he is showing a broad range of properties. In reality, this type of broker simply wants to point out bad things about the other agents' properties, and then take the perspective buyer to his own listings. In this case, it is very easy to forget to leave a card at the house. The listing agent and seller have no way of knowing that their property is being used by an unscrupulous broker with no intention of selling it. There is also no way to know if the perspective buyer made an offer, or how much a offer was, since any offer is reported from the broker.

Security in other types of presentations, sales and transactions is also very difficult to achieve. There is generally no record of who as been presented to or made an offer, when, how many times, what was said, what was offered, whether there was a counter-offer or an acceptance. The elderly are particularly vulnerable to fraud from contractors, real estate agents, insurance agents and many other types of presenters or salesmen who want to enter into transactions.

What is badly needed is a system and method that would monitor who enters into properties, presentations, sales or transactions, only allow them to enter if they are authorized, record any offers, and keep statistics as to when a property, if a property is involved, was shown, how long it was shown, and record in an indelible way any offers made. Such a system would be applicable to any type of presentation or transaction by keeping a complete record of who, when and what transpired every time there is an interaction or transaction between a seller or offeror and a buyer or offeree or any other access to the presentation or transaction.

The system of the present invention can also facilitate international transactions by providing translation of terms involved in the transaction or to gain access and can translate documents for transactions in different languages for different nationalities. The present invention can provide services to assist consumers with the acquisition, finance, current governmental policy on foreign national taxation and immigration. A biometric virtual signature accompanying each piece of information involved in the transaction can improve the ease and security of international business.

### SUMMARY OF THE INVENTION

The present invention relates to a system and method for presentations, sales and transactions that assures fairness and security by limiting access and recording any and all interactions with the transaction. The present invention provides fraud preventions and fiduciary accountability by accurately preserving and making available information on who gained access and when. Biometric data can be collected from anyone attempting access to a property or other aspect of a transaction. Aside from simply providing access security, the present invention can provide credibility for the entire transaction process, from beginning to end, by recording any conversation, Email, fax or other correspondence or communication relating to the transaction. For example, a digital or virtual signature can be enhanced to contain biometric data.

The present invention can optionally be split into a computer part and a security part. The computer part can be separated from the security part, or it can be co-located with it. In the case of real estate, the computer part can provide a database that can record information when a property is shown that is provided by the security part. In addition, the computer part can optionally provide advanced services such as mortgage information and procurement, generating closing information, providing insurance information or actually selling both title insurance and home owners insurance, financial information and financial planning, legal background, credit information, buyer pre-qualification, translation, and sales advice. For other types of transactions, the security part can record data concerning the participants in any interaction between a presenter/seller and a perspective buyers or transactees.

For real estate, the security part of the system could be located on the premises of a property being sold. It could totally replace a lock box. Because real estate professionals generally belong to associations that govern their conduct and ethics, such an organization could mandate the use of such a system. In this case, the computer part of the system could be run by such an organization or association and contain a list of both the names and some identifying features of all individuals authorized to show homes or properties from a multi-listing service.

In any type of presentation, sales or transaction system, the security part of the system can have positive identification capabilities such as finger print, voice scan, retinal scan, face feature scan, or any other means or method for positive personal identification. For a real estate listing, the security part could record attempts to enter a property, check if the person is authorized, allow access if authorized, record time in and time out, and generally act like a very smart lock box. It could be coupled to existing alarm systems so that when access is allowed, the alarm is disabled, and when the showing is over, the alarm system is re-enabled. For other types of transactions, it could be the gate-keeper to any presentation or subsequent transaction.

The computer part of the system could communicate with one or many security parts, record all information from security parts in a data base, make secure and authenticated entries of offers including property or transaction, time, amount, buyer, seller or presentee name and information, selling agent information and any other information related to the offer. Communication between the computer portion and the security portions could be by any possible data communications technique including cellular telephone, land-line telephone, cable, DSL or any other way.

Presenters, sellers or listing agents could pay a service fee to the central computer part service to use the service. The fee could be based on the level of service desired. It is also possible for buyers or other presentees/transactees to pay for use of the service. Payment could be made by subscription or could be on a “per click” basis.

### DESCRIPTION OF THE DRAWINGS

FIG. 1 is a block diagram of an embodiment of the present invention.

FIGS. 2A, 2B and 2C show embodiments of a door mounted systems and a smart lock-box system for use in real estate transactions.

FIG. 3 is a flow chart of possible actions taken when a person approaches a real property.

FIG. 4 is a flow chart of alternate actions that can be taken when a person approaches a real property.

FIG. 5 is a flow chart of possible actions taken when a person phones the system in any type of transaction.

FIG. 6 is a block diagram of a transaction control system.

Several illustrations and figures have been presented to aid in a better understanding of the present invention. The scope of the present invention is not limited to the figures.

### DESCRIPTION OF THE INVENTION

The present invention relates to a system and method for allowing a real property or any other type of service or item to presented or sold fairly by putting things such as access for showing, offers, inquiries and other parts of the sale process under control of a concierge system. In many cases, this system can be mandated by a professional association like a real estate association, insurance association, and broker association or other and can be used as a standard part of each listing or presentation. Fees can be charged for use of the system based on the level of service desired. In the case of real estate, the present invention also addresses issues involved with allowing prospective buyers and/or necessary service people or providers into a home or property.

The system can contain a security part and a computer part. The computer part can control many different security parts located at different properties or presentation locations. The security parts generally can control access to properties or the presentation, take biometric data or other positive identification from persons attempting to enter, record entry times, exit times and perform other local services at the property or site of the presentation or transaction.

The computer part can communicate with the security parts and can contain a database. In the real estate case, the database can contain a list of people directly authorized to enter a particular property such as the owner and family as well as agents who are members or who subscribe to the service who might show the property. In other cases, the database can contain all the particulars of the presentation or transaction including all parties related to it and their role. The computer part can communicate with the security parts. The preferred method of communication is by cellular telephone or land-line telephone; however, any convenient communication method is within the scope of the present invention including, but not limited to, land-line telephone, cable, other radio services, DSL or any wired or wireless communication method. The communication does not have to be continuous. In fact, the preferred method is to have the security part call the computer part when an access is attempted or when the security part needs to share or access information to or from the database.

The security part of the system can take positive identification data from persons attempting to enter the real property or take part in some facet of a presentation or transaction. Identification can be by any method of positively identifying a person that exists now or that might exist with future developed technology. This includes, but is not limited to, all types of biometric data such as finger prints, retinal scan, face feature scan, and face recognition, body feature scan such as finger lengths, palm prints, voice scan, DNA and any other identification method. In one embodiment of the invention, an agent could simply enter a code number or PIN to gain access. In this case, the system either locally, or through communication with the computer part, could look up the code number or PIN to determine and record access.

The present invention can also address the needs of the For Sale by Owner community by providing the ability to also track access and transactions for persons selling their own real estate. In addition, the present invention can provide the ability for a seller to auction a property on a web page or otherwise while completely tracking bids, prices and final price as well as the later payment and closing transactions.

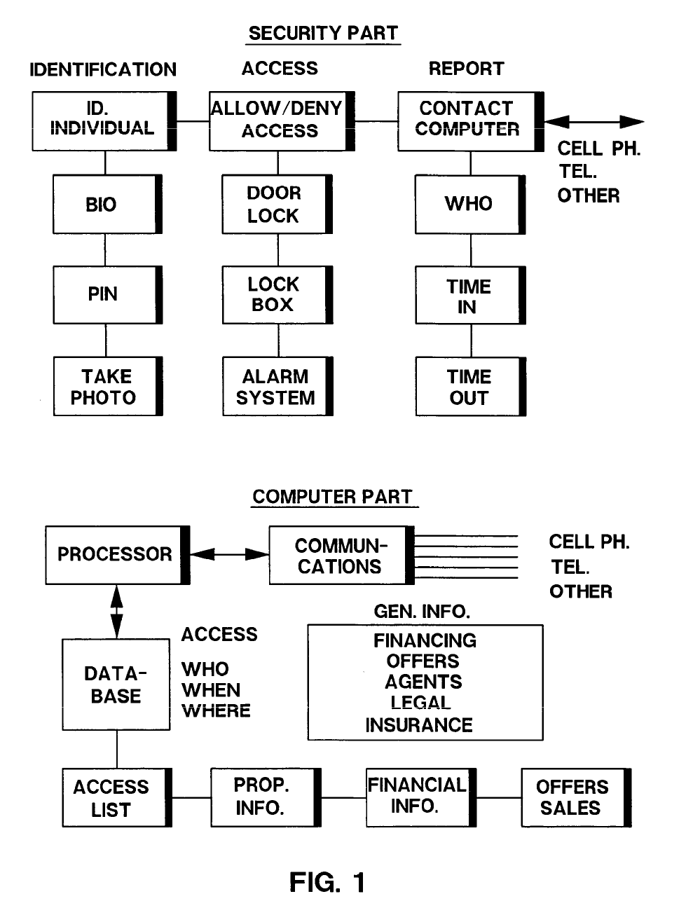

FIG. 1 shows an overview of an embodiment of the present invention in block diagram form. The upper part of FIG. 1 shows an embodiment of the security part of the system; the lower part of FIG. 1 shows an embodiment of the computer part of the system. Starting at the upper left hand corner, the first problem the present invention solves is identification of an individual seeking access to a property, presentation or transaction. The system must ID the individual. This can be done with biometric techniques, a PIN number and other methods. A photograph can be taken of the person. Biometric techniques can include finger prints, retinal scans, face feature scans, other body part comparison (finger length for example), DNA and any other biometric method of identifying an individual. Alternatively or in addition, a PIN number, agent number or other identifier could be entered by the person. In the case of a real estate agent, it could be his or her association number, broker's license number or simply an issued PIN number. Optionally, the system could be run under manual control. The system could take a photo of the person (or supply a live video) to an operator located in a central location. Upon comparison of the photo with a database, a PIN number could be issued that would allow entrance (or entrance could be granted directly by communication with the property security system). Any method of identifying an individual is within the scope of the present invention.

In the case of real estate sales the present invention solves the problem of access to the property. If the person seeking access has been properly identified, the system can allow access. Access can be by unlocking a door, opening a gate, opening a lock box to reveal a key, or by any other access method. In addition, if the property has a security system, the system should optionally notify that system so that it does not alarm.

Another problem solved by the present invention is to report (or record) what is happening. For example, in the case of a failed access (failed identification, etc.), a photo and data about the attempted entry can be communicated to a central location. In the case of a successful identification and access, data as to who the person is and when the access took placed can be communicated (or recorded). In addition, it is advantageous to also communicate or record the time the person or persons leave and the property is secure again. A device could for example be attached to a door on a house or entrance to other property that triggered a camera that caused a photo or video to be recorded on who had entered and what they had done while there. The camera could have an optional fisheye lens.

Communication can take place by cellular telephone, telephone land-line, other radio services, cable, fiber, DSL or by any other communication method or technique that exists now or will be invented. It should be noted that the entire system can be self-contained in one embodiment of the invention where all actions and data recording are local with no separate computer part.

Turning to the lower part of FIG. 1, the computer part of an embodiment of the present invention is shown. A processor communicates with a database and a communications port. The communications can be as described above. The database can contain access lists, optional biometric data for people allowed access, and should record events such as attempted and/or successful accesses. In each case, it is desirable to record who it was and when it occurred. As stated, it is also advantageous to record exit times. From entrance and exit times, durations can be computed.

The computer part can also supply property information about the property, presentation or transaction that might be of interest to buyers or agents, financial information such as pre-qualifications of potential buyers, and records of any offers made on the properties and any sales contracts made. The present invention allows users to call the computer part to obtain allowed information. For example, a seller may wish to obtain a list of potential buyers who have viewed a property or presentation (or if there is a privacy issue, a list of how many times it has been showed). A listing agent or presenter may wish to see what other agents have shown the property or have been involved in the presentation or transaction. A selling agent may wish to check that his showing of the property was recorded. A seller, buyer, listing agent or selling agent may wish to see the exact terms of any offer made or any contract made.

In addition to the services listed above, the present invention can optionally provide general information such as tips or leads that may aid in the completion of the transaction. For example, in the case of real estate, the invention can provide information about financing or obtaining a mortgage, general information about making offers or sales negotiations, background information about various agents, general legal information concerning real estate and sales, and insurance information, both title insurance and home owners insurance. The present invention can optionally supply information about any topics useful to users.

One embodiment of the invention can go further than simply recording an offer, sale or presentation. This embodiment can produce information and forms needed for closing, keep track of dates and closing costs, keep track of different parties involved such as lenders, title companies, attorneys and others, and provide reminders to parties concerning the closing date, the amounts needed on checks, other papers needed, and any other information useful to complete or translate the sale. Generally this information can be entered into the system by the various parties involved such as the agents, title company, lender and attorney. Finally, the system could make sure that the various official documents that need recording actually do get recorded such as the deed, mortgage, note, etc. in the case or real estate or any other transaction documents in the more general case. This information can be entered and closed out by the parties involved in the transaction. This particular embodiment of the present invention allows the complete data for a transaction to reside in a single standard, protected database from the time of the listing or first presentation to the time the sale or transaction is complete and recorded.

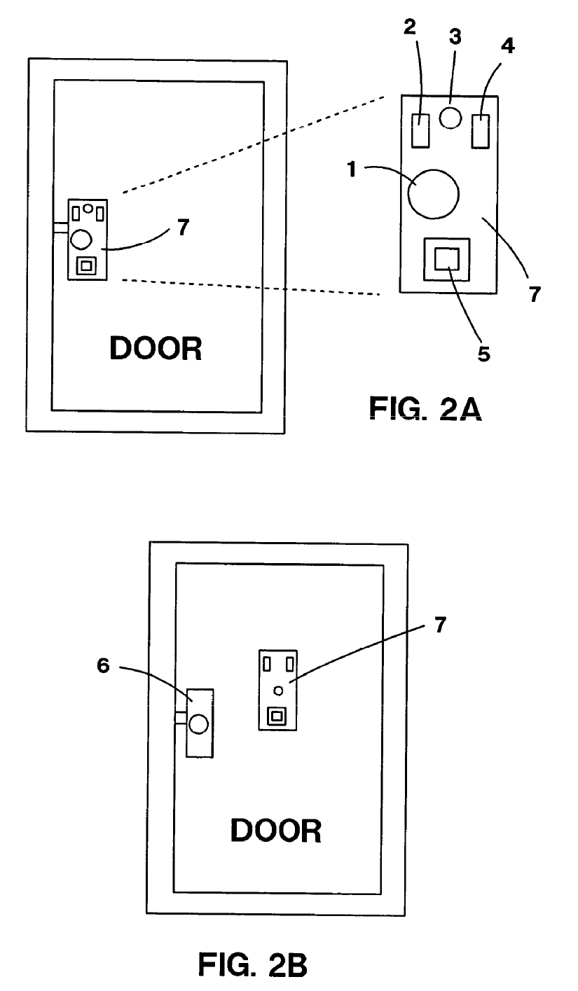

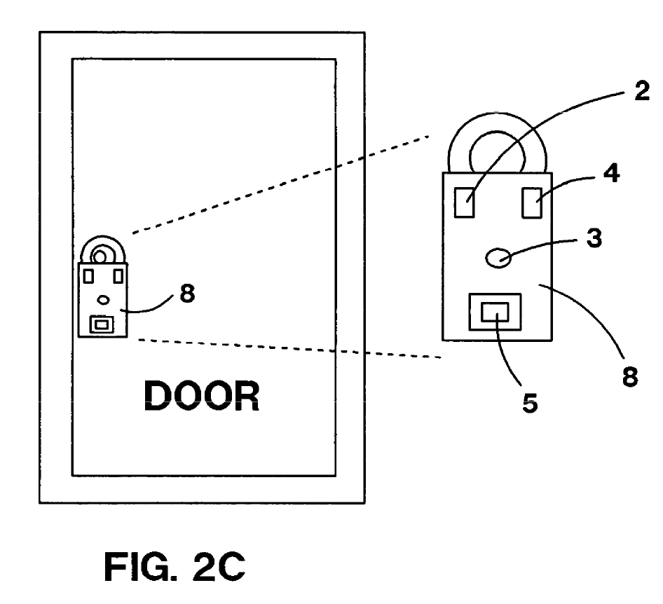

FIG. 2A shows a door-lock embodiment of a portion of the present invention 7 for use in the case of real estate. Such a device can function as an access barrier to the property. In this embodiment a special latch can be provided that can contain electronics and can also open the door electronically. The unit can be equipped with a regular door knob 1 a speaker 2, a microphone 4, and a camera 3. In addition the unit can contain a biometric input device 5. This device can be a fingerprint acquisition unit or other device for measuring some parameter about the person trying to enter that can result in a positive identification. An alternate embodiment is shown in FIG. 2B where the electronic unit is put in the middle of the door. The electronics 7 can also be inside the door with the optional camera working through an existing peep-hole. A standard or electric latch 6 can be used on the door. If a standard latch is used, the door must be opened by the owner or agent; if an automatic or electric latch is used, it may be able to be opened remotely.

A person seeking access to a property could approach the door, be photographed, and then speak or otherwise enter a PIN or pass-code. Identification could be made by facial feature recognition from the photo, or a fingerprint or other biometric feature could be taken by the biometric input device. The local device could then either look up who is allowed access, or could place a cellular telephone call to a central location where it could be determined if the person should be allowed access.

FIG. 2C shows a smart lock-box 8 similar to the units shown in FIGS. 2A-2B. Here, the lock-box 8 itself contains the electronics and an optional cellular telephone. The lock box can contain a speaker 3, microphone 4, camera 3 and biometric input device 5. The units shown could also be located other places, such as curb-side or elsewhere, and could have key pads so that numbers or letters could be entered.

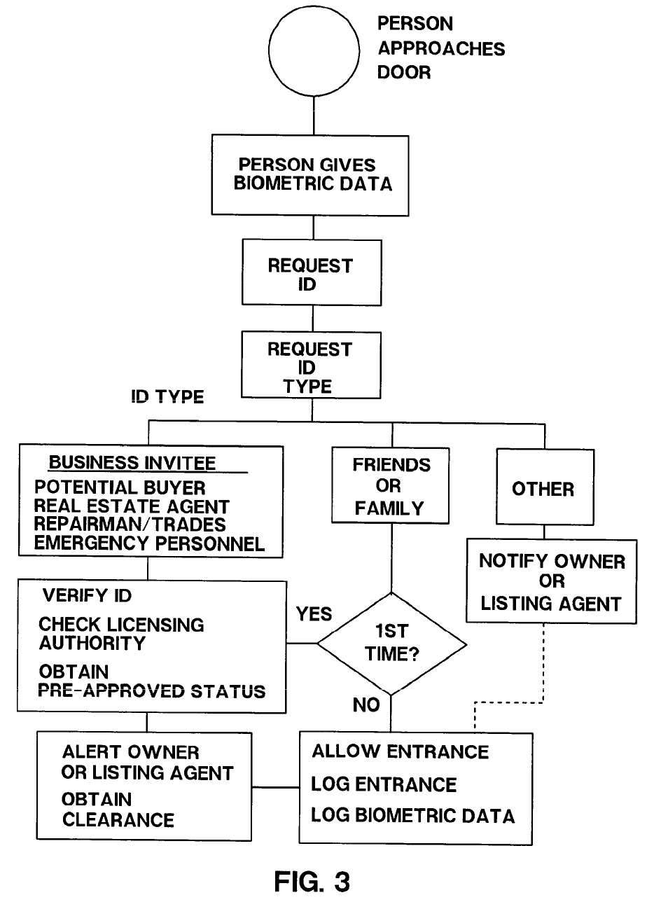

FIG. 3 shows a flowchart of possible actions that could be taken when someone approaches a door unit. The steps of this flowchart are for example only; the steps can be performed in different order; some steps could be omitted, and other steps could be added.

As seen in FIG. 3, when the person approaches, he or she can first submit to a fingerprint, thumbprint, palm-print or other bio-scan to activate the system. Biometric data could then be collected by the system such as a fingerprint, a retinal scan, a digital image of the face or a face point scan and possibly a voice recording. An ID could be optionally requested, and the person could then be allowed to select an access category. The choices shown in FIG. 3 are business invitee, friends and family and other. The category other simply means person not otherwise named. Business invitees can include potential buyers, real estate agents, repair and trades, and possibly emergency personnel. Business invitees (except for emergency personnel) normally will have pre-checked with the listing agent or owner and gotten a pre-approved status. They will be asked to possibly enter an access code. Their entrance and egress can be logged and optionally reported to the listing agent or owner. Their biometric identification data can also be logged for future comparison. Family members should generally enroll the first time they enter, and then be allowed entrance thereafter. Friends also may enroll once, and then enter subsequently by simply notifying the owner. Any other party will generally not be admitted; however, the listing agent or owner can be notified of the attempt to see if entrance should be authorized.

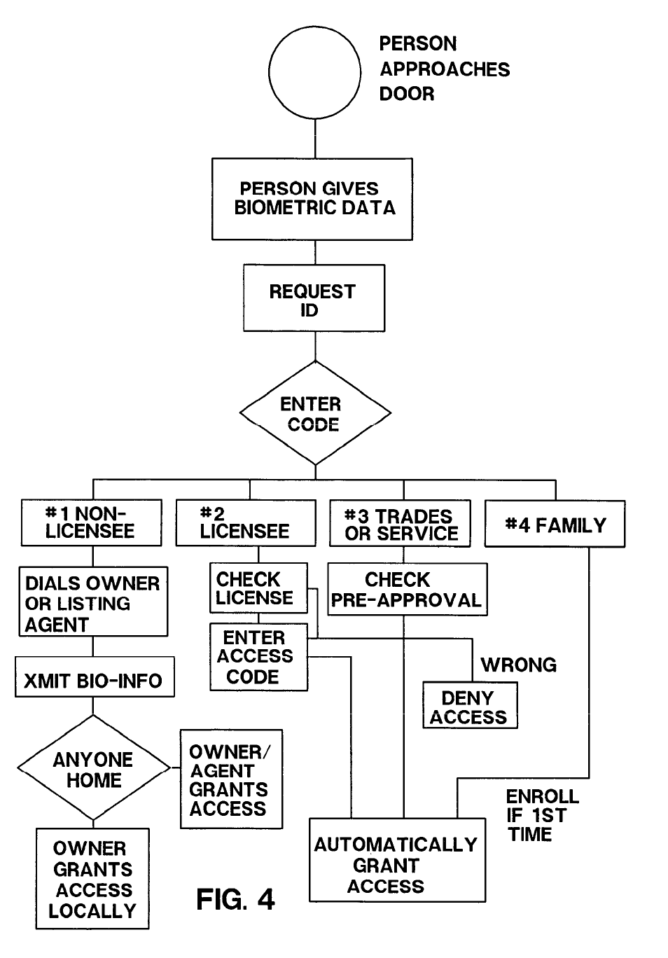

FIG. 4 shows an alternative flow chart of possible actions when someone approaches a property. Again the person activates the system by entering biometric data or by some other method (including simply approaching the door, or hitting some sort of start key). An ID can be optionally requested, and then the person can be asked to enter a choice number. Some of the possible choices could be non-licensee, licensee, trades person or family. A trades-person may have to enter a pre-arranged code to show that he or she is expected. This code can be obtained from the listing agent or owner by pre-qualifying either in person or by telephone or internet connection. Family members could be quickly identified and admitted. Friends could be vouched for by family members. A licensee is one who has a right to enter on their own, but is not friends or family. Such a person might be the listing agent and others. The licensee is one who has a license and could possibly enter an additional PIN or access code that could be checked against a database along with the biometric data. This code could relate to their license. All entries and exits by such a person could be recorded in the database. The system, upon verifying that the licensee should be admitted, could automatically open the door or lockbox. A licensee, for example, could be a broker from another agency who is showing the property from a multiple listing service.

A non-licensee is someone who may have a right to enter, but who is not on the “known” or “recognized” list or category. Such a non-licensee could be anyone who is not in any of the previous categories and does not have a professional license. This non-licensee cannot usually be admitted automatically. In this case, the system could dial the listing agent or owner, and let the person seeking admission talk over the telephone. The listing agent or owner could then send a signal that would cause the door or lock box to open.

The system can be directed in its operation by what number is entered in the beginning of the process. For examples, there can be numbers for licensed real estate brokers/sales agents, potential buyers, other professionals such as mortgage or insurance professionals, tradesman such as carpenters, painters, plumbers, etc., an appraiser, an inspector, and other parties. An example is shown in FIG. 4 where #1 being a non-licensee, #2 being licensee, #3 being trades or service and #4 being family, etc.

The system can provide a virtual (electronic) trail (like a paper trail) of all parties, conversations, offers, counter offers, acceptances and inspections that are pertinent or relevant to the transaction. The system of the present invention can provide this with the added benefit of a highly verifiable biometric signature of any and all of the participants who access the property.

By selecting #2 in the above example, the collected data for the licensed professional could be cross-referenced against a real estate database. All professional licensees could be required to be fingerprinted in order to receive a license. Also, licensees could be digitally photographed at testing centers when they take their qualifying tests or when they are issued their licenses. Social security numbers could also be used for cross-reference.

Once a professional was verified, they could use the key pad to request the lock box to issue the key if the owner was not at home or the property was vacant. In addition, professionals could call and request the owner to open the door or box locally or remotely. An owner or listing agent could grant access by placing a telephone call to the box and entering a special code. The system could further allow the agent to call the owner or listing agent and connect them by phone or cellular telephone into a conference. It is possible to conference the listing agent and an owner husband and wife all in different locations.

Persons attempting access can be connected to the owner or listing agent in a direct connect mode in order to allow a live conversation. A potential buyer could enter his or her phone number if they want to be contacted directly, or they could specify a time on the key pad or by voice for the listing agent or owner to call. The data from the prospect could be collected and stored.

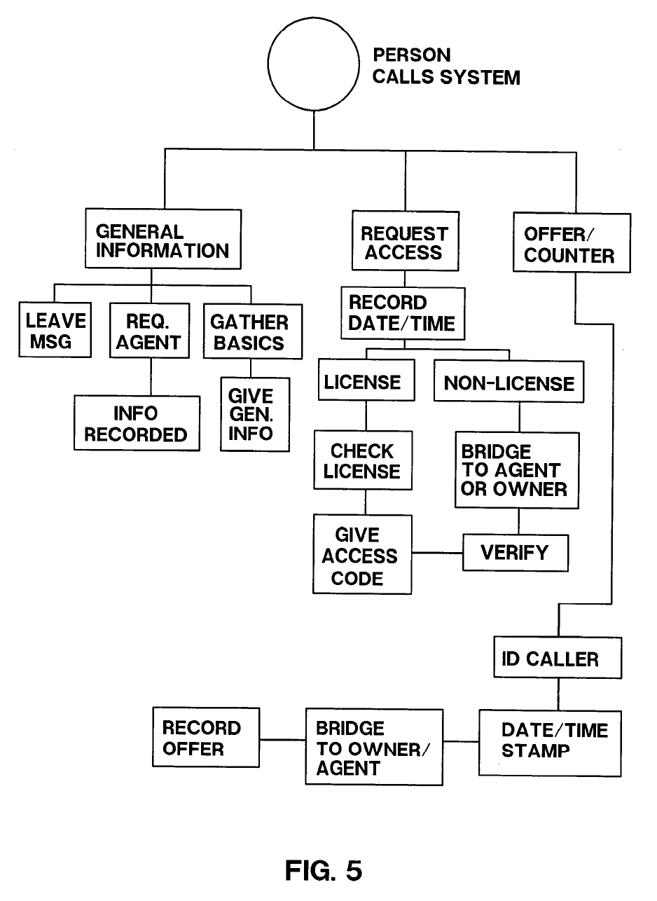

A feature of the present invention is that it can be called remotely and handle incoming telephone calls. The system could have its own telephone number and could be called from any phone. The person calling could receive pre-recorded showing instructions or key-in to request to speak with the listing agent, presenter or owner. FIG. 5 is a flowchart of what may optionally happen when the system is called. The first step can be to identify what type of user is calling. It can be somebody who simply desires information (such as the price, age of the house, features of the house, etc.); it can be someone who wishes to schedule access; it could be someone who wants to make an offer, or it could be an incoming fax or Email.

If the caller simply wants information, the system can direct the caller to a menu of available information. If the person wants other information, they can be bridged or connected to the listing agent or owner. If no one is available to take the call in that case, the call could be directed to voice mail in the normal way. If the person is setting up a showing or otherwise needs access to the property, the system can determine if they are a licensee or non-licensee, and set up a time and date when access can be had. In the case of a non-licensee, the listing agent or owner may optionally be required to give authorization. For a licensee, license information should be taken down and recorded in a database, and an appointment given. The listing agent or owner can be optionally notified.

In the case of an offer or counter-offer, the caller should be identified by requiring the entry of name, phone number, etc. and a voice recording should be made with a date/time stamp. Automatic caller ID can be optionally recorded. The offer can be entered by voice, or to prevent errors, by telephone touch tone key entry. The call can be bridged to the listing agent or owner. Such a telephone offer may not be legally binding in some states. If the offer is rejected, this is not a problem; however, if the offer is to be accepted, the listing agent or owner may follow-up with a written sales contract. An offer can be handled by setting up a conference call with the listing agent, selling agent or others. All calls in such a conference mode could be recorded with the permission of the parties at a central location. This would provide a tangible record of what was said and when it was said and by whom.

Incoming faxes or Email can be date/time stamped and put into a proper inbox for that type of communication. All other conversations and data could be stored in a database at the central location or central computer. This would provide verifiable data to the owner, agents, licensing body or to a court in the case of legal proceedings in the case of a dispute.

A feature of the present invention is its ability to keep track of everyone who enters a property in terms of who, when and why; keep track of offers, counter-offers and even negotiations; and provide information and communication links about the property or the business being brokered. Generally, professional organizations such as national realtor's organizations could manage and mandate the use of the system by their members. The present invention “levels the playing field” by keeping track of every detail that transpires from the time the property or business deal is assigned to the system until the time of closing or when the deal is completed.

One feature of the present invention is fraud prevention in any type of transaction. With rapid advances in technology portable biometric identification and collection units will become common. A particular embodiment of the invention could have the user taking the system with him/her to meetings with their financial professional or any others. The user could ask the professional to collect his/her data finger print, voice, and image or retinal scan at the meeting, or perhaps with industry saturation he/she may have their own collection unit at the office that they would as collection and validation for them to protect themselves from unwarranted lawsuits pertaining to suitability in the securities industry, or insurance sales.

With various embodiments of the present invention, financial communications could be collected and recorded either in person, over the phone, or even via email. The technology mated to the internet could solve the issue of virtual signatures allowing greater security and control of electronic communication and would be a huge cost saving solution while providing fraud prevention internationally. The participants by entering the data could have acknowledged their acceptance of the terms of use and collection so as not to violate any civil rights. A user doing nothing wrong you should not have a problem with the system. If a professional that a party is dealing with does not want to use the system, this could be a signal that the user might not want to deal with that professional. The system of the present invention could be used outside of the professional forum with the private sector for necessary goods and services, and especially with the elderly to prevent fraud. An example might be with senior health service and home health care providers.

The computer part of the present invention can reside on one or more servers and can be made accessible over the internet. Agents, buyers and others should be able to access the system to get information, make appointments, possible gain access to the property and to make offers and counter-offers. The system can contain a recording device that is attached to a cellular telephone or other communications method for recording what transpires at meetings.

In addition to the embodiments of the present invention that have been described, part or all of the invention can be implemented in a hand-held mobile unit. This unit can be equipped with GPS for location determination and transmission as well as having the ability to communicate with other parts of the system. In particular, GPS location could be used to verify that a particular party performed a particular act where and when they claimed.

Histories of offers can be particularly tracked by the present invention. Every offer can be record as to date/time made, amount, offer or and any other desired data. Once an offer is accepted, that fact can also be entered in order to lock out subsequent offers. Such a lock-out can be removed by the listing agent if the deal falls through or for other reasons. Once the property or deal closes, the system can be notified to not give any more information out. For real estate, lock boxes, etc. can usually be removed after a property closes.

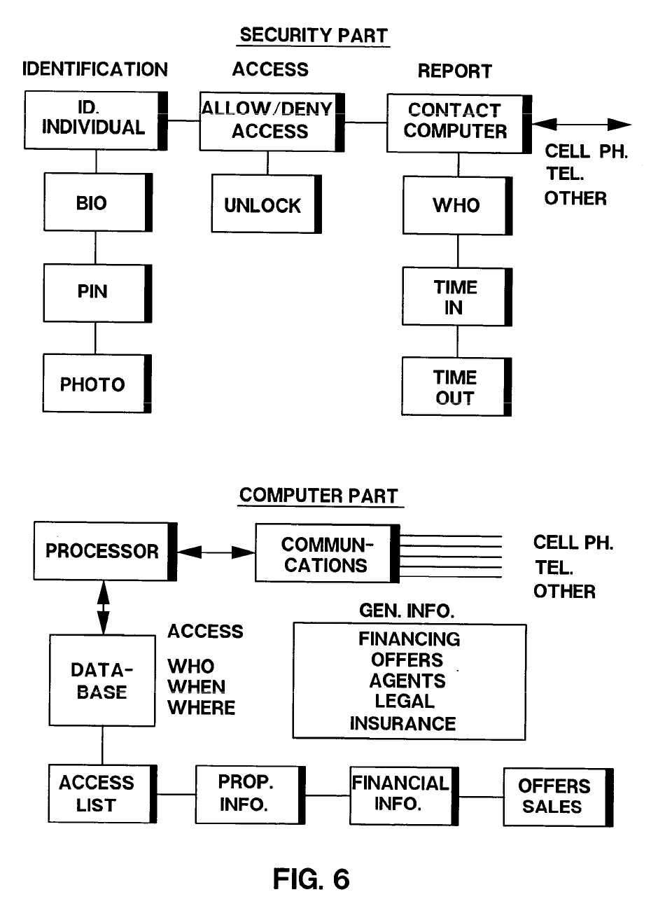

FIG. 6 shows an overview of a general transaction embodiment of the present invention in block diagram form. The upper part of FIG. 6 shows an embodiment of the security part of the system; the lower part of FIG. 6 shows an embodiment of the computer part of the system. The embodiment of FIG. 6 is like that shown in FIG. 1 except that it applies to transactions that are more general than real estate.

Several descriptions and illustrations have been presented to better aid in the understanding of the present invention. One skilled in the art will recognize the many changes and variations are possible. Also many other embodiments and examples of the construction and functioning of the invention could be presented. All of these changes, variations, embodiments and examples are within the scope of the present invention.

I claim:

1. A method of access control and fiduciary accounting for a transaction including monitoring and recording each of: 1) all attempts to gain access to said process, 2) positive identification of all persons allowed access to said transaction, 3) all data or documents added or deleted from said process, 4) all offers to buy or sell, 5) all acceptances of offers to buy or sell, 6) phone conferences relating to said process, 7) faxes relating to said process, 6) email messages relating to said process, and further comprising the step of sharing said results of said monitoring and recording with all persons authorized for access to said transaction.

2. The method of claim 1 wherein said process is a real estate transaction.

3. The method of claim 1 further comprising providing mortgage to a buyer after acceptance by a seller.

4. The method of claim 1 further comprising providing all forms needed for closing.

5. The method of claim 1 wherein said positive identification is by biometric parameter.

6. The method of claim 1 wherein all telephone calls related to said process are recorded.

7. The method of claim 1 wherein all emails and all faxes related to said process are recorded.

8. The method of claim 1 wherein a geographic determination is made for a person attempting to gain access to said transaction.

9. The method of claim 8 wherein said geographic determination is by GPS.

10. The method of claim 1 wherein automatic caller ID is recorded for each person accessing said transaction by telephone.

11. The method of claim 1 wherein subsequent offers and acceptances are locked out upon acceptance of an offer.

12. The method of claim 1 wherein a role is defined for each person allowed access to said transaction.

13. The method of claim 12 wherein a person allowed access to said transaction is locked out of any action not defined by said person's role.

14. A method of access control and fiduciary accounting for a real estate transaction including monitoring and recording each of: 1) all attempts to gain access to said process, 2) positive identification of all persons allowed access to said transaction, 3) duration of all accesses, 4) all data or documents added or deleted from said process, 5) all offers to buy or sell, 6) all acceptances of offers to buy or sell, 7) all phone conferences relating to said process, 8) all faxes relating to said process, 9) all email messages relating to said process, and further comprising the step of sharing said results of said monitoring and recording with all persons authorized for access to said transaction, and wherein said positive identification is by biometric parameter, wherein a role is defined for each person allowed access to said transaction; and wherein a person allowed access to said transaction is locked out of any action not defined by said person's role.

15. The method of claim 14 wherein automatic caller ID is recorded for each person accessing said transaction by telephone.

16. The method of claim 14 wherein subsequent offers and acceptances are locked out upon acceptance of an offer.

17. The method of claim 14 wherein a geographic determination is made for a person attempting to gain access to said transaction.

18. The method of claim 14 wherein said geographic determination is by GPS.
